(19) United States
(12) Patent Application Publication
(10) Pub. No.: US 2014/0366734 A1
(43) Pub. Date: Dec. 18, 2014

(54) AIR PURIFICATION DEVICE

(71) Applicant: Eusebio Moro Franco, L'Alcora (Castellon) (ES)

(72) Inventor: Eusebio Moro Franco, L'Alcora (Castellon) (ES)

(21) Appl. No.: 14/117,088

(22) PCT Filed: Apr. 23, 2012
(86) PCT No.: PCT/ES2012/070271

§ 371 Date: Jan. 27, 2014

(30) Foreign Application Priority Data
May 12, 2011 (ES) P201130764

(51) Int. Cl. B03C 3/36; B01D 50/00; B01D 53/04

(52) U.S. Cl. CPC B03C 3/366; B01D 53/0407; B01D 50/00; B03C 2201/30
USPC 96/55; 96/60

(57) ABSTRACT

The device has air ducts (21, 22) in which a fan/aspirator (4) is interposed, passive and mechanical air-filtration elements (2, 11, 13) being placed before the unit (3) formed. At the exit from said unit (3) there is an active filtration module that includes one or more non-thermal plasma conduits (6). When the ducts (22) closest to the module (7) bifurcate or branch inside said module (7), they define at least two clear air outlets (12), said unit (3), said module (7) and a filter (2) of said passive and mechanical filtration elements being connected to a control unit (5) by means of a communication (8) selected from mechanical, electrical, electronic and optoelectronic means and any combination thereof. The device can be used in land, water, air or space vehicles (10).

### OBJECT OF THE INVENTION

The present invention, as expressed in the wording of this specification, relates to an air purification device which essential purpose is facilitating a small environmental air purification system applied to a land vehicle; however, its application to all kinds of stationary or mobile vehicles should not be ruled out, including water, land, air or space vehicles because, due to the configuration, architecture, and type of filters used, the device allows operations with very diverse flow rates, flows, and capacities of the airs being handled, using glass ball filters, electrostatic filtration elements and others, including HEPA filters and DBD reactors, to achieve the foregoing. With it, a vehicle, whether or not it has polluting characteristics in its propulsion or operation, may be turned into an element that delivers cleaner air than the air it picks up to the environment, the dirt particles remaining in the device itself, with which an important means to counteract the pollution of the air to which the device is applied is defined. Another purpose of the invention consists of its application to any conventional vehicle without significant incompatibilities with respect to makes, ventilation types used, and other characteristics.

### BACKGROUND OF THE INVENTION

There are many filtration devices that are known, which are adapted to automobile vehicles to capture and filter air, both inside the vehicle and for its discharge into the atmosphere, cleaning the air of smoke, suspended particles, pollen, and other pollutants.

However, turning a vehicle into a mobile air purifier has not been generalized, there being background in that sense such as U.S. Pat. No. 3,738,088. This document already intended to turn a vehicle into a mobile air purifier, there being inconveniences, advantages, and infeasibilities of different kinds that determined that its implementation in the engine of a vehicle and the filtration methodologies would not achieve an optimal operation.

Currently, there are many automobiles having multiple systems to capture and filter air, as well as the gases and pollution particles generated in their engines, but they lack the characteristic of providing cleaner air than the one they pick up to the environment, such that they become a more purifying rather than polluting element.

On the other hand, document EPA-456/R-05-006, dated on November of 2005, of the Environmental Protection Agency—EPA—of the United States, is known, which stated the following: “using non-thermal plasma to control air pollutants”, and was prepared by the Clean Air Technology Center (CATC). Said document explains the DBD non-thermal plasma reactor, which uses an internal electrode and an external electrode in a coaxial arrangement and has a glass bead filler, just like a part of the device of the invention that is intended to be protected.

On the other hand, HEPA (High Efficiency Particulate Air) filters are known, which consist of high efficiency air filters used in biomedicine, planes, cars, and trains.

A patent document reflecting the use of these HEPA filters is patent ES 2266818, consisting of, as expressed in its abstract, a system to create a positive or negative pressure in a selective manner in a selected portion of the space of a room.

On the other hand, electrostatic filters applied to air recirculation units are also known, as reflected by the two-phase electrostatic filter of patent ES 2113049.

Other documents of the state of the art related to the invention are American patents U.S. Pat. Nos. 3,534,530 and 3,070,971.

We are not aware of any air purification device in the current state of the art presenting the architecture, possibilities of application, and feasibility explained in this document, as provided by the practical example and the claims of the present invention.

### DESCRIPTION OF THE INVENTION

In order to achieve the objectives and avoid the inconveniences indicated in the previous sections, the invention consists of an air purification device that comprises at least one water, air, space, or land vehicle, and which includes at least air intakes and outlets; such that the intakes receive a flow of dirty air and the outlets provide at least one flow of clean air.

In a novel manner, according to the invention, the device thereof has air ducts in which a fan/aspirator is interposed, passive and mechanical air-filtration elements being placed before the unit formed by said ducts and fan/aspirator. At the exit from said unit there is an active filtration module that includes one or more non-thermal plasma conduits, such that when the ducts closest to the module bifurcate or branch inside said module, they define at least two clear air outlets, said unit, said module and a filter of said passive and mechanical filtration elements being connected to a control unit, and the aforementioned vehicle and control unit being integrated by means of a communication selected from mechanical, electrical, electronic and optoelectronic means and any combination thereof.

In some embodiments of the invention, the aforementioned non-thermal plasma conduits are provided with at least one electrostatic filter. In a particular embodiment, said electrostatic filter(s) incorporated to the non-thermal plasma conduits may incorporate an active carbon membrane.

In addition, in each one of the aforementioned non-thermal plasma conduits in these or in other embodiments of the invention, there may be at least one filter consisting of a dielectric barrier discharge (DBD) non-thermal plasma reactor made by means of a tube provided with at least one coverage with the functions of an external electrode, glass beads determining a filler through which the air passes, and a core with the functions of an internal electrode, as is the case of the preferred embodiment of the invention.

At least in said preferred embodiment of the invention, the aforementioned passive and mechanical air-filtration elements consist of one or more dirty air inlets leading the dirty air from the intakes in the vehicle to coarse particle pre-filters, which in turn are connected to a HEPA filter from which outlet the air is taken to the ducts of the aforementioned set.

In the preferred embodiment of the invention, where the device is applied to a conventional land vehicle or automobile provided with two headlights, two rear lights and a front air intake, respective clean air outlets are arranged under the rear lights, while the dirty air inlet is found between the headlights behind the general air intake of the vehicle.

With the structure described above, the device of the invention has advantages with respect to its applicability to a conventional vehicle, given that the grille or general air intake of the vehicle can be taken advantage of to grab the dirty air, to make the clean air outlet in proximity to the conventional exhausts, and to place the filters and the fan/aspirator, as well as the ducts, in the lower part of the vehicle, which entails the direct application to existing models without having to destroy the chassis or undertake expensive operations, the invention being obviously applicable to makes and models that could come out in the near future in which the invention would be incorporated at the manufacturer's, such that the road traffic, instead of becoming a pollutant, may even become an environmental cleaning agent. Another advantage of the invention is that, when using electrostatic filters activated with electronic means and having a glass bead filler in the dielectric space of the corresponding electrostatic actuation electrodes, it allows applications in diverse sizes and speeds of the vehicle incorporating the same, the invention being operative in land, water, air, or space vehicles, and in mobile and stationary vehicles with respect to the environmental system of reference.

On the other hand, the device of the invention has the advantage that its cost of production is relatively low in the majority of the conceivable applications, given that materials such as glass, economical metal alloys, conventional coarse particle filters, and fans/aspirators, are used, and together with the envisaged gates and valves, may be commanded from a simple electronic control in the case they are not regulated directly by the intervening air currents.

Next, in order to facilitate a better comprehension of this specification and being an integral part thereof, figures representing the object of the invention in an illustrative rather than limitative manner have been attached.

### BRIEF DESCRIPTION OF THE FIGURES

FIG. 1.—Represents a functional block diagram of an air purification device, made according to the present invention.

FIG. 2.—Represents a transverse section of an air duct-filter or DBD reactor used in the preferred embodiment of the device of the invention.

FIG. 3.—Represents an application of the preferred embodiment of the invention by means of a lower plant view of a vehicle incorporating the device.

FIG. 4.—Represents a profile view of the vehicle of the previous FIG. 3.

FIG. 5.—Represents a front elevational view of the vehicle of the previous FIGS. 3 and 4.

FIG. 6.—Represents a rear elevational view of the vehicle of the previous FIGS. 3, 4 and 5, wherein the preferred embodiment of the device of the invention is incorporated.

### DESCRIPTION OF AT LEAST ONE EXAMPLE OF AN EMBODIMENT OF THE INVENTION

A description of an example of the invention, taking the references of the figures into account, is made below.

First, we shall provide a list reflecting the references of the drawings:
1: Air intakes
2: HEPA (High Efficiency Particulate Air) filter
3: Unit of ducts connected to 4
4: Fan/aspirator interposed in 3
5: Control unit
6: Non-thermal plasma conduit
7: Bifurcated active filtration module
8: Information coming from the automobile
9: Dirty environmental air
10: Vehicle
11: Particle pre-filter
12: Clean air outlet
13: Dirty air inlet
14: Clean air
15: Headlights of the automobile
16: Rear lights of the automobile
17: Air arriving to the active filtration module 7
18: External electrode of a DBD reactor of a non-thermal plasma conduit
19: Internal electrode of a DBD reactor of a non-thermal plasma conduit
20: Glass bead filler of a DBD reactor of a non-thermal plasma conduit
21: Ducts from 2 to 4
22: Ducts from 4 to 7

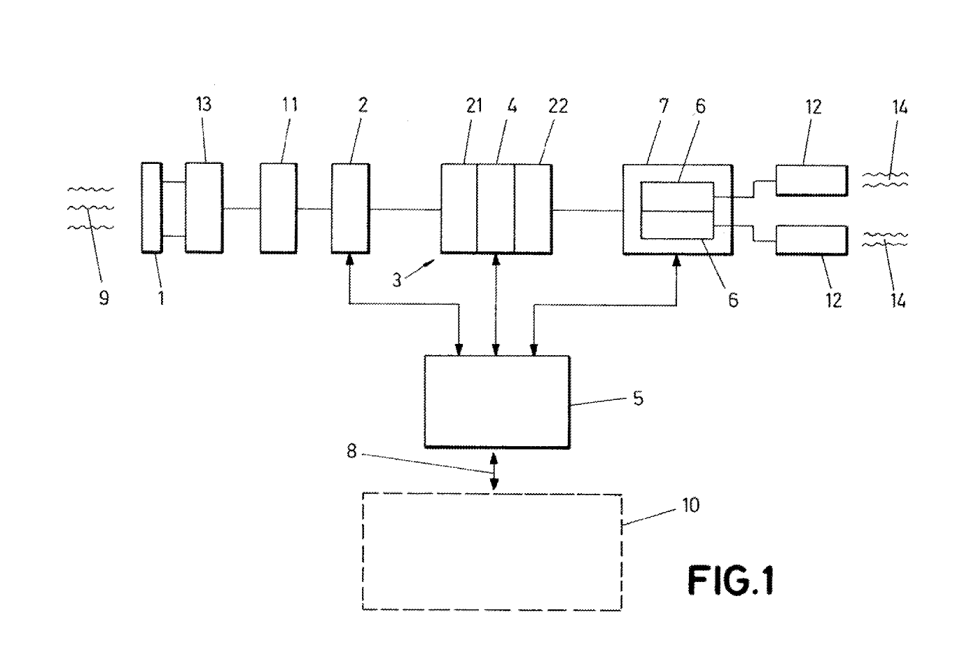

As shown in FIGS. 1 to 6, which accompany this example of the invention, the air purification device thereof comprises a land vehicle 10, shown in FIGS. 3 to 6, although it may be another vehicle in other examples, stationary or mobile with respect to an environment that is the same or different from the environment of this example.

In FIG. 1, which shows the functional block diagram of vehicle 10, we can see how the air inlets 1 and outlets 12 of the vehicle 10 provide or pick up dirty 9 or clean 14 air flows.

Said block diagram represents air ducts 21, 22 in which a fan/aspirator 4 is interposed, forming a unit 3. Said air ducts 21, 22 and fan/aspirator 4 can also be seen in FIG. 3.

On the other hand, the aforementioned block diagram shows how said set 3 is connected to the active filtration module 7, the HEPA filter 2, and to the control unit 5, which in the present example can be integrated in the electronic block of the vehicle 10, given that its functions in this case are only simple commands, such as turning the valves, gates, fans, and aspirators on and off and simple flow rate and air speed calculations for the optimization of the performance and duration of the filters of the device.

The passive and mechanical air-filtration elements 2, 11 and 13 are placed before the unit 3, while the module 7 is provided with one or more non-thermal plasma conduits 6. Respective dielectric barrier discharge (DBD) non-thermal plasma reactors are placed in these conduits 6, although in other examples of the invention other types of electrostatic or non-electrostatic filters could be placed, according to the available technologies, the vehicles to which the device is applied, and other conditions.

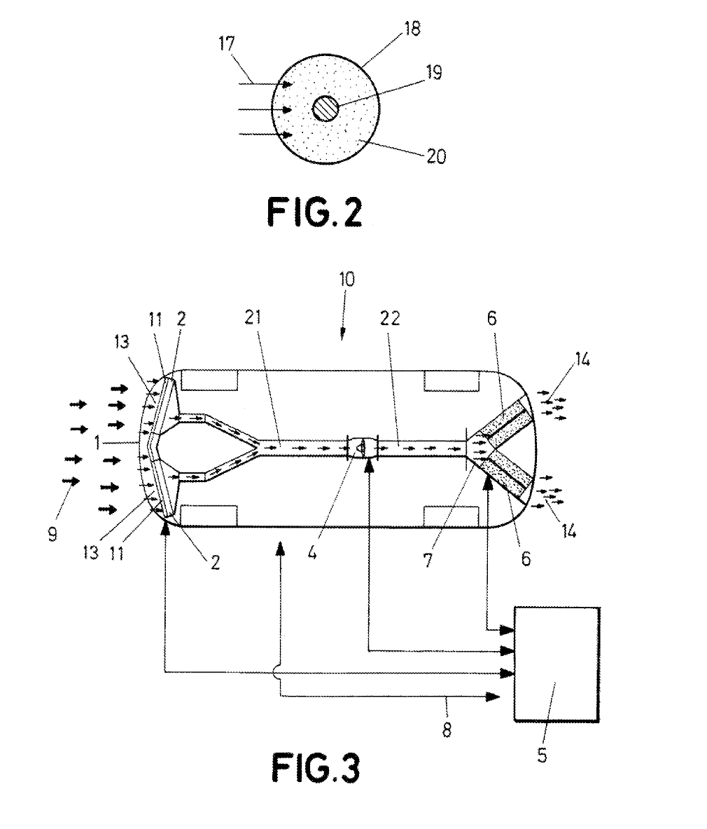

Said reactors and conduits 6, as well as the passive and mechanical air-filtration elements 2, 11, 13, are also shown in the aforementioned FIG. 3. In addition, a transverse cut of said reactor is shown in FIG. 2, where its constitution by means of a tube provided with a coverage with the functions of an external electrode 18, the filler 20, determined by glass beads, through which the air 17 passes to be cleaned, and the core 19 with the functions of an internal electrode, can be seen.

In this example of the invention, the communication 8 between the control unit 5 and the vehicle 10, represented in the block diagram of FIG. 1, is electrical and electronic, but in other applications it may simply be mechanical, optoelectronic, or any combination allowed by available technology in the required application.

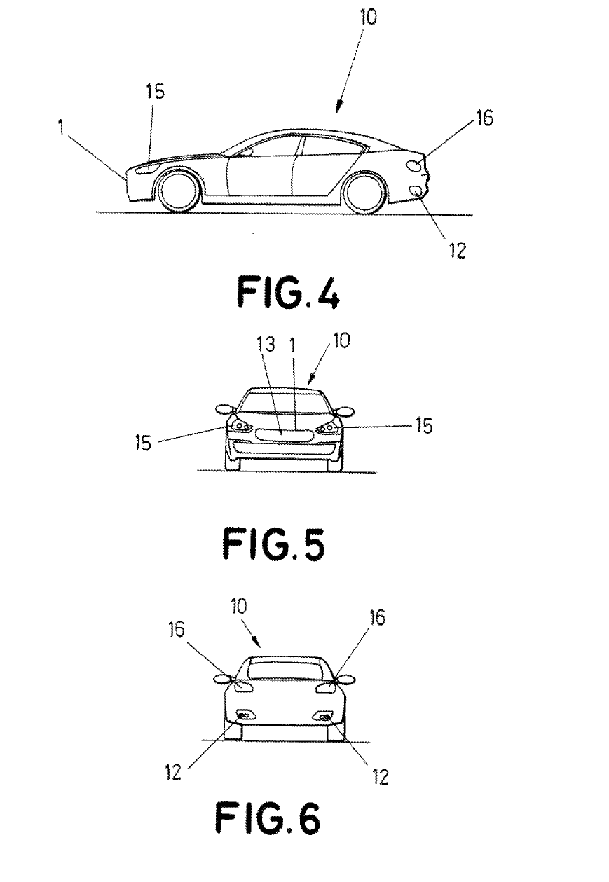

FIGS. 4 to 6 show the specific situation of the clean air outlets 12 and the dirty air inlets 13 with respect to the headlights 15 and the rear lights 16 of the automobile 10, which in the aforementioned views is shown as a profile view, a front elevational view, and a rear elevational view, respectively.

1. Air purification device, comprising at least one water, air, space or land vehicle, and including at least air intakes and outlets; such that the intakes receive a flow of dirty air and the outlets provide at least one flow of clean air; wherein the air purification device comprises: air ducts in which a fan/aspirator is interposed, passive and mechanical air-filtration elements being placed before a unit formed by these ducts and the fan/aspirator where at the exit from said unit there is an active filtration module that includes at least one non-thermal plasma conduits so that when the ducts closest to the module bifurcate or branch inside said module, the ducts define at least two clear air outlets; said unit, said module and a filter of said passive and mechanical filtration elements being connected to a control unit; and the vehicle and the control unit being integrated by means of a communication selected from mechanical, electrical, electronic and optoelectronic means and any combination thereof

2. Air purification device according to claim 1, wherein each one of the non-thermal plasma conduits is incorporated to at least one electrostatic filter.

3. Air purification device according to claim 1, wherein in each one of the aforementioned non-thermal plasma conduits, there is at least one filter consisting of a dielectric barrier discharge (DBD) non-thermal plasma reactor made by means of a tube provided with at least one coverage with the functions of an external electrode, glass beads determining a filler through which the air passes, and a core with the functions of an internal electrode.

4. Air purification device according to claim 1, wherein the passive and mechanical air-filtration elements consist of one or more dirty air inlets leading the dirty air from the intakes in the vehicle to coarse particle pre-filters, which in turn are connected to a High Efficiency Particulate Air (HEPA) filter, from which outlet the air is taken to the ducts of the unit.

5. Air purification device according to claim 1, wherein under each one of the two rear lights presented by the vehicle, there is a clean air outlet, while between the two headlights of said vehicle, a dirty air inlet is arranged in the general air intake of the vehicle.

6. Air purification device according to claim 2, wherein the at least one electrostatic filter incorporated in the non-thermal plasma conduits (6) incorporates an active carbon membrane.

7. Air purification device according to claim 2, wherein in each one of the aforementioned non-thermal plasma conduits, there is at least one filter consisting of a dielectric barrier discharge (DBD) non-thermal plasma reactor made by means of a tube provided with at least one coverage with the functions of an external electrode, glass beads determining a filler through which the air passes, and a core with the functions of an internal electrode.

8. Air purification device according to claim 2, wherein the passive and mechanical air-filtration elements consist of one or more dirty air inlets leading the dirty air from the intakes in the vehicle to coarse particle pre-filters, which in turn are connected to a High Efficiency Particulate Air (HEPA) filter, from which outlet the air is taken to the ducts of the unit.

9. Air purification device according to claim 3, wherein the passive and mechanical air-filtration elements consist of one or more dirty air inlets leading the dirty air from the intakes in the vehicle to coarse particle pre-filters, which in turn are connected to a High Efficiency Particulate Air (HEPA) filter, from which outlet the air is taken to the ducts of the unit.

10. Air purification device according to claim 2, wherein under each one of the two rear lights presented by the vehicle, there is a clean air outlet , while between the two headlights of said vehicle, a dirty air inlet is arranged in the general air intake of the vehicle.

11. Air purification device according to claim 3, wherein under each one of the two rear lights presented by the vehicle, there is a clean air outlet , while between the two headlights of said vehicle, a dirty air inlet is arranged in the general air intake of the vehicle.

12. Air purification device according to claim 4, wherein under each one of the two rear lights presented by the vehicle, there is a clean air outlet, while between the two headlights of said vehicle, a dirty air inlet is arranged in the general air intake of the vehicle.

13. Air purification device according to claim 7, wherein under each one of the two rear lights presented by the vehicle, there is a clean air outlet, while between the two headlights of said vehicle, a dirty air inlet is arranged in the general air intake of the vehicle.

14. Air purification device according to claim 8, wherein under each one of the two rear lights presented by the vehicle, there is a clean air outlet, while between the two headlights of said vehicle, a dirty air inlet is arranged in the general air intake of the vehicle.

15. Air purification device according to claim 9, wherein under each one of the two rear lights presented by the vehicle, there is a clean air outlet, while between the two headlights of said vehicle, a dirty air inlet is arranged in the general air intake of the vehicle.
